(19) United States
(12) Patent Application Publication
(10) Pub. No.: US 2011/0124335 A1
(43) Pub. Date: May 26, 2011

(54) ENHANCED PLMN LIST

(76) Inventors: Hans MARTIN, Bad Salzdetfurth (DE); Christian MUCKE, Petershausen (DE)

(21) Appl. No.: 12/625,860

(22) Filed: Nov. 25, 2009

(51) Int. Cl. H04W 48/18; H04W 4/02

(52) U.S. Cl. 455/434; 455/456.3

(57) ABSTRACT

The present disclosure relates to generating a candidate network credential list based on position information. In one implementation, the candidate network credential list includes public land mobile networks (PLMNs) that are available in a geographic region associated with the position information. In another implementation, the candidate network credential list may be a subset of a larger network credential list stored in a wireless device.

### BACKGROUND

There are a significant number of frequencies available for communication in mobile communication systems. This large number of frequencies has increased the amount of time needed for a user equipment (UE), such as a mobile phone or other remote terminal, to select public land mobile networks (PLMNs), for instance during power-up and loss-of-service scenarios.

Mobile communication systems include time-division multiple access (TDMA) systems, such as cellular radio telephone systems that comply with the global system for mobile communications (GSM) telecommunication standard and its enhancements like GSM/EDGE, and code-division multiple access (CDMA) systems, such as cellular radio telephone systems that comply with the IS-95, cdma2000, and wideband CDMA (WCDMA) telecommunication standards. Digital communication systems also include combined TDMA and CDMA systems, such as cellular radio telephone systems that comply with the universal mobile telecommunications system (UMTS) standard, which specifies a third generation (3G) mobile system being developed by the European Telecommunications Standards Institute within the International Telecommunication Union's IMT-2000 framework. The Third Generation Partnership Project (3GPP) promulgates the UMTS and WCDMA standards.

3G mobile communication systems based on WCDMA as the radio access technology (RAT) are being deployed all over the world. High-speed downlink packet access (HSDPA) is an evolution of WCDMA that provides higher bit rates by using higher order modulation, multiple spreading codes, and downlink-channel feedback information. Another evolution of WCDMA is Enhanced Uplink (EUL), or High-Speed Uplink Packet Access (HSUPA), that enables high-rate packet data to be sent in the reverse, or uplink, direction. New RATs are being considered for evolved-3G and fourth generation (4G) communication systems, although the structure of and functions carried out in such systems will generally be similar to those of earlier systems. In particular, orthogonal frequency division multiplexing is under consideration for evolved 3G and 4G systems.

Current and future communication systems may require a UE to locate a best possible PLMN for serving the UE by performing a PLMN selection process. At power-on of the UE, a PLMN list stored in the UE may be referenced to determine an appropriate PLMN to serve the UE. The PLMN list may include a home public land mobile network (HPLMN), an equivalent home public land mobile network (EHPLMN), and other PLMNs that may be specified by a wireless communication network provider. The PLMN list may also be referenced after the UE initiates a PLMN reselection process. Such a PLMN reselection process may occur when the UE moves outside the coverage area of a registered PLMN (RPLMN) currently serving the UE. The PLMN reselection process may also occur upon expiration of a timer associated with the UE. There may be other scenarios in which the UE is required to access and search the PLMN list.

Although the current PLMN list generally provides the UE with sufficient resources to enable the selection of a PLMN, the process of searching the PLMN list, which may include PLMNs that are currently unusable by the UE, places demands on the UE that unnecessary deplete battery power. Efficient use of battery power is increasingly important in the current mobile UE market. Moreover, searching the PLMN list consumes time, which may influence when the UE will be available for use. A user's evaluation of the UE may be significantly affected by how quickly the UE is able to respond operationally.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different instances in the description and the figures may indicate similar or identical items.

FIG. 1 is a diagram of a communication network that may be in communication with a user equipment (UE) that implements a candidate network credential list according to the implementations described herein.

FIG. 2 is a diagram of a wireless device or apparatus that may be provisioned to store and generate a candidate network credential list according to the implementations described herein.

FIG. 3 is a flow diagram of a procedure to generate a candidate network credential list according to the implementations described herein.

FIG. 4 is a flow diagram of a procedure that may be used in connection with the procedure illustrated in FIG. 3, for example, to further enhance a candidate network credential list.

FIG. 5 is a flow diagram of a procedure 500 that may be used in connection with the procedures illustrated in FIGS. 3 and 4, for example, to further enhance a candidate network credential list.

### DETAILED DESCRIPTION

The following description describes implementations related to storage of a candidate network credential list that may be used by user equipment (UE) to quickly and efficiently select a wireless network provider for providing wireless network services to the UE. The candidate network credential list may include a plurality of wireless network provider entries that the UE may select and join to obtain wireless network services, such as cellular telephone and data services. In one implementation, each wireless network provider entry in the candidate credential list is a public land mobile network (PLMN) entry. One or more of the implementations described herein generate the candidate network credential list based on position information associated with the UE. One or more of the network credentials associated with the generated candidate network credential list may be chosen from network credentials stored in the UE and/or a UICC 218 and/or a storage module 224. Generating the candidate network credential list based on position information may produce a candidate network credential list that includes wireless network provider entries, such as PLMN entries, that are likely available in a geographical area that the UE is currently located.

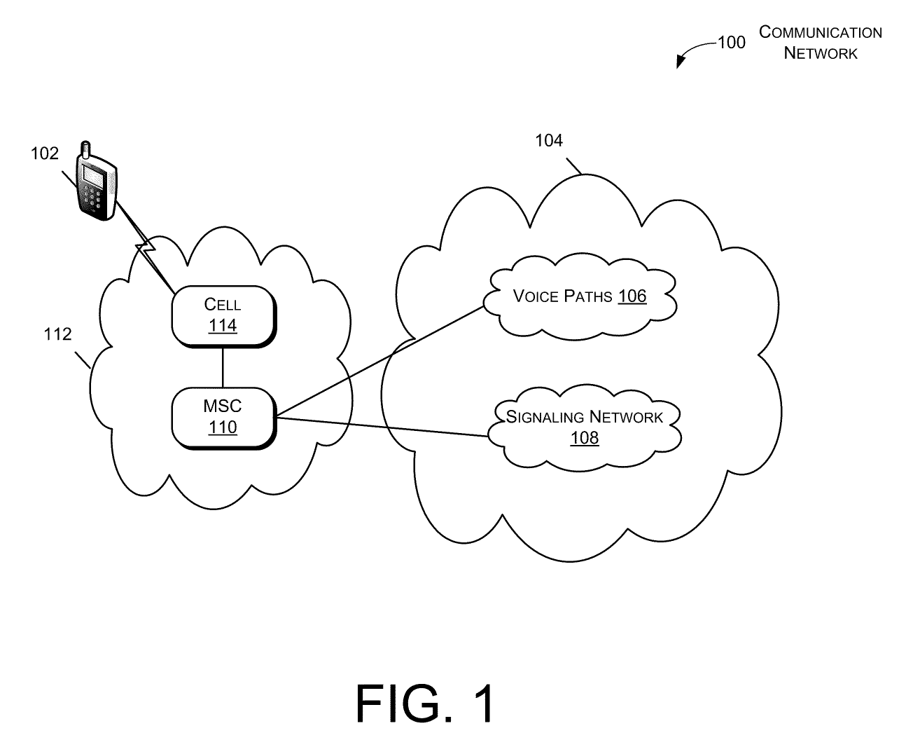

FIG. 1 is a diagram of a communication network 100 that may be in communication with a UE 102 that implements a candidate network credential list according to the implementations described herein. In one implementation, the candidate network credential list includes one or more public land mobile network (PLMN) entries that the UE 102 may select. Selection of a PLMN may enable the UE 102 to wirelessly connect to a cell associated with the selected PLMN. More specifically, the candidate network credential list may include one or more candidate network credential entries, which may include mobile network code (MNC), mobile country code (MCC), radio access technology (RAT) identifier, center frequency, and/or a related band, associated with a wireless network. More generally, the candidate network credentials associated with the credential list may simply identify wireless networks that the UE 102 may connect with. The UE 102 may be a mobile phone, wireless capable computer, or another wireless communication device type.

The communication network 100 may include a Publicly Switched Telephone Network (PSTN) 104. The PSTN 104 may generally include a plurality of voice paths 106 and a signaling network 108 that handles data communication. Other components, which are known, such as signal transfer points, tandem switching systems, local switching systems, selective routers, and the like, are not illustrated in the communication network 100 of FIG. 1.

A mobile switching center (MSC) 110 may be connected to the PSTN 104 via both the voice paths 106 and signaling network 108. The MSC 110 may be part of a PLMN 112. For simplicity, a single PLMN 112 is illustrated. However, there may be multiple PLMNs 112 in a given geographical area, and any one of the multiple PLMNs 112 may be utilized by the UE 102. In general, the UE 102 and the PLMNs 112 may be utilized within any number of wireless communication systems including, but not limited to, time-division multiple access (TDMA) systems, such as cellular radio telephone systems that comply with the global system for mobile communications (GSM) telecommunication standard and its enhancements like GSM/EDGE, and code-division multiple access (CDMA) systems, such as cellular radio telephone systems that comply with the IS-95, cdma2000, and wideband CDMA (WCDMA) telecommunication standards; and digital communication systems also include combined TDMA and CDMA systems, such as cellular radio telephone systems that comply with the universal mobile telecommunications system (UMTS) standard, which specifies a third generation (3G) mobile system being developed by the European Telecommunications Standards Institute within the International Telecommunication Union's IMT-2000 framework. Such wireless communication systems may implement high-speed downlink packet access (HSDPA), which is an evolution of WCDMA that provides higher bit rates by using higher order modulation, multiple spreading codes, and downlink-channel feedback information. Another evolution of WCDMA is Enhanced Uplink (EUL), or High-Speed Uplink Packet Access (HSUPA), that enables high-rate packet data to be sent in the reverse, or uplink, direction. Furthermore, such wireless communication systems may include new RATs that are being considered for evolved 3G and fourth generation (4G) communication systems.

The MSC 110 may be connected to a plurality of cell sites, represented herein as a cell site 114, either directly or via base station controllers (not illustrated). Each cell site 114 supports telephony functions for a plurality of mobile communication devices, represented by the UE 102 that implements a wireless device or apparatus that may be provisioned with a candidate network credential list according to the implementations described herein.

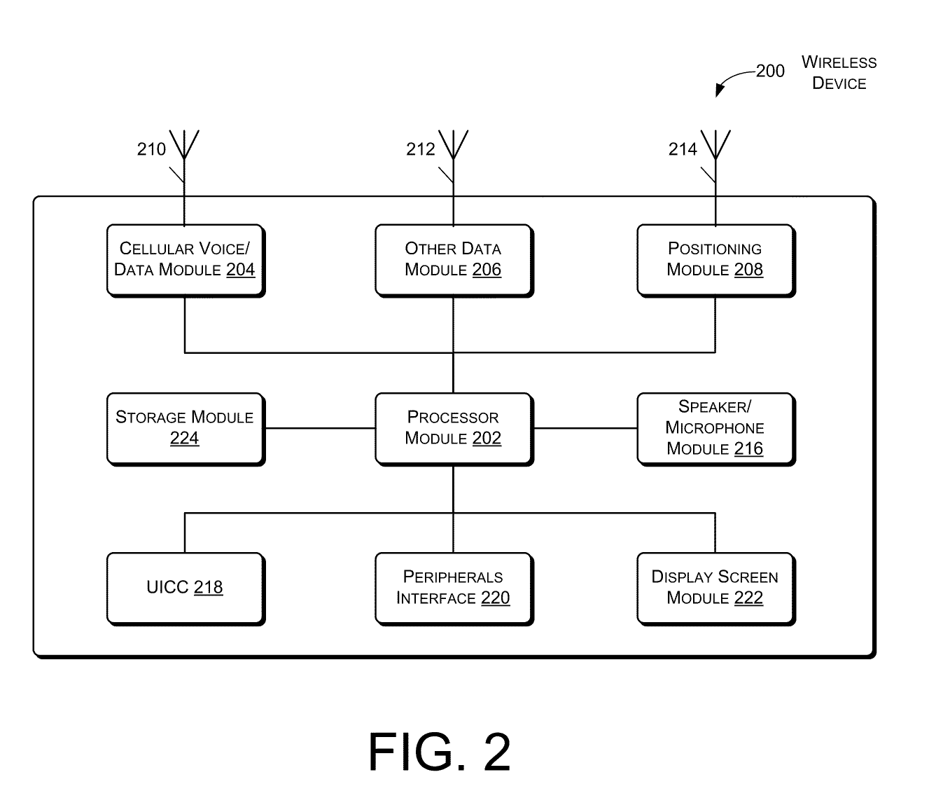

FIG. 2 is a diagram of a wireless device, UE or apparatus 200 that may be provisioned to generate and store a candidate network credential list according to the implementations described herein. The wireless device or apparatus 200 may include a processor module 202 coupled to a plurality of wireless modules that enable the wireless device or apparatus 200 to communicate wirelessly. The wireless modules may include a cellular voice/data module 204, an other data module 206 (e.g., Bluetooth module), and a positioning module 208 (e.g., GPS module). The wireless device or apparatus 200 is not limited to the illustrated wireless modules. Each of the wireless modules is coupled to an antenna 210, 212 and 214, respectively. Although the antennas 210, 212 and 214 are shown as separate antennas, a single unitary antenna may also be used and coupled to the modules 204-208.

The processor module 202 may also be coupled to a speaker/microphone module 216, an integrated circuit card (UICC) loaded with a subscriber identity module (SIM) or a universal subscriber identity module (USIM) 218, a peripherals interface 220 and a display module 222. Furthermore, the processor module 202 may be coupled to a storage module 224. The storage module 224 may be a nonvolatile storage or volatile storage.

The UICC 218 and/or the storage module 224 may include a comprehensive network credential list. Alternatively or in addition, the wireless device or apparatus 200 may store a comprehensive network credential list in another storage associated therewith. Each network credential in the list may be associated with a wireless communication network that may be used by the wireless device or apparatus 200. The candidate network credential list according to at least an implementation described herein may include one or more network credentials that are identified or listed in a comprehensive network credential list that is stored in the wireless device or apparatus 200 and/or in the UICC 218 and/or the storage module 224. In one implementation, each candidate network credential is a PLMN entry.

The wireless device or apparatus 200 may be configured to transmit and receive voice and data communications to and from the MSC 110 via the cell site 112. Such communications may include voice communications directly from a user and via the speaker/microphone module 216, data generated from peripherals coupled to the peripherals interface 220 and received via the display screen module 222, and positioning information from the positioning module 208.

Depending on the targeted implementation, the wireless device or apparatus 200, or parts thereof, may be an integral part of a larger system, such as a vehicle. Alternatively, the wireless device or apparatus 200, or parts thereof, may be a separate component included in a device such as a portable cellular or personal communication system (PCS), a pager, or a hand-held computing device such as a personal digital assistant (PDA).

Each of the wireless modules 204-208 includes a transmitter to transmit and encode voice and data messages using antennas 210-214, respectively, via an over-the-air protocol such as CDMA, WCDMA, GSM, TDMA, or the like. The wireless modules 204-208 may also be configured to transmit by other wireless communications, such as satellite communications. Each of the wireless modules 204-208 also includes a receiver to receive and decode voice and data messages from the cell site 112 and the MSC 110, or any other component associated with the communication network 100. Such received voice and data messages may be received via an over-the-air protocol such as CDMA, WCDMA, GSM, TDMA, or the like. The wireless modules 204-208 may also be configured to receive other wireless communications, such as satellite communications. The transmitters and receivers may be integrated transceiver devices.

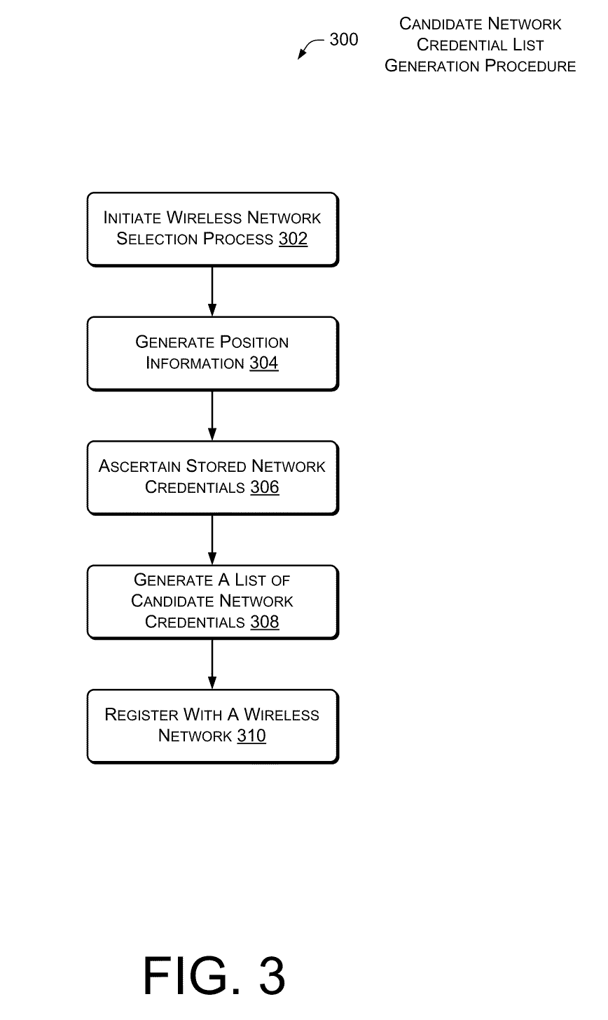

FIG. 3 is a flow diagram of a procedure 300 to generate a candidate network credential list according to the implementations described herein. Reference may be made to FIGS. 1-2 to aid the discussion of the candidate network credential list generating procedure. However, the candidate network credential list generating procedure is compatible with wireless networks and devices other than those illustrated and discussed herein.

Specifics of exemplary procedures are described below. However, it should be understood that certain acts need not be performed in the order described, and may be modified, and/or may be omitted entirely, depending on the circumstances. Moreover, the acts described may be implemented by a computer, processor or other computing device, such as a wireless device, based on instructions stored on one or more computer-readable storage media. The computer-readable storage media can be any available media that can be accessed by a computing device to implement the instructions stored thereon.

At Act 302, a wireless device, such as the UE 102, initiates a wireless network selection process. Such a wireless network selection process may occur when a transceiver associated with the wireless device 102 is enabled, when the wireless device is powered-on, or when the wireless device is otherwise attempting to access another wireless network due to operational requirements, or the like. In one implementation, the wireless network selection process is a PLMN selection process performed by the wireless device.

At Act 304, the wireless device determines or generates position information. In one implementation, the position information may be geographical radius information generated based on a time period elapsed between a transceiver disabled state and the transceiver enabled state. A center of the generated radius information may be an estimated or predetermined position of the wireless device determined before the transceiver is placed in a disabled state. The wireless device may include a processor, such as the processor module 202, that executes a timer instruction set when the transceiver transitions to a disabled state. The timer instruction set may track the elapsed amount of time until the transceiver subsequently transitions to an enabled state. Alternatively, the processor module 202 may enable a hardware timing device associated with the wireless device to track the elapsed time. In another implementation, the position information may be geographical radius information generated based on a time period elapsed between a power-off state and a power-on state of the wireless device. A center of the generated radius information may be an estimated or predetermined position of the wireless device determined before the wireless device is placed in a power-off state. In foregoing implementations, the geographical radius information may be enhanced by considering an estimated velocity of the wireless device. That is, knowing the estimated velocity of the wireless device, coupled with the timer and center information, may enable the determination of highly accurate geographical radius information. As those of ordinary skill in the art appreciate, distance information and time may be used to calculate speed or average speed. The wireless devices described herein are functionally capable of determining distance information using position information and time using integrated capabilities of the devices.

In yet another implementation, the position information is determined using satellite positioning technology. In particular, the wireless device may incorporate the positioning module 208 that is compatible with positioning technologies (e.g., GPS, GLONASS, and Galileo). Such an enabled wireless device is capable of accurately determining its geographical position.

In another implementation, the wireless device, as part of the wireless network selection process, identifies information associated with a wireless network that is available to the wireless device. Such information may indicate position information that may be use by the wireless device to generate the position information in Act 304. For example, the wireless device may identify one or more active PLMNs during the wireless network selection process, where the one or more PLMNs include position information (e.g., geographical regions, MCC, MNC, etc.) that may be used by the wireless device in the process of generating the position information in Act 304.

In another implementation, the wireless device, by way of the other data module 206, may use short-range wireless communications (e.g., WiFi, RFID, etc.) to generate the position information. For example, certain WiFi frequency bands may be used in certain geographical regions and prohibited in other regions. Therefore, it may be possible to at least exclude certain regions as being included in the generated position information based on detection of certain WiFi frequency bands. Alternatively, frequency band information related to RFID may be used to generate the position information.

In another implementation, the wireless device may use voltage level information to generate the position information. For example, the wireless device may detect a coupled to AC voltage level. The detected AC voltage level may be used to estimate the location of the wireless device. The estimated location may be used to generate the position information in Act 304.

The foregoing exemplary information types that may be used to generate the position information of Act 304 are not exhaustive. Furthermore, the exemplary information types may be used individually, as a plurality, or collectively to generate the position information of Act 304.

At Act 306, the wireless device may access a storage associated therewith, such as the UICC 218 and/or the storage module 224, to ascertain the network credentials that are stored therein. In one implementation, the storage includes a list of PLMNs, such as a home PLMN (HPLMN), an equivalent home PLMN (EHPLMN), a registered PLMN (RPLMN), and other PLMNs. Each of the network credentials or PLMNs in the storage may have associated information. The associated information may include a RAT indicator that specifies the RAT(s) supported by a given PLMN, a band group (BG) or frequency band supported by the given PLMN, the MCC associated with the given PLMN, and the MNC associated with the PLMN. The network credentials included in the storage may be a comprehensive or static list of network credentials, or may be a comprehensive list of network credentials that is updated from time-to-time by one or more wireless network entities associated with the communication network 100.

At Act 308, the wireless device may generate a list of candidate network credentials from the network credentials ascertained in Act 306. In one implementation, the wireless device uses the generated or determined position information of Act 304 as a basis for determining which network credentials to include in the generated list of candidate network credentials. As described earlier herein, the position information may be geographical information that indicates the current country, region, radius, and/or area in which the wireless device is currently operating. Therefore, such position information may be used by the wireless device to identify network credentials that should be excluded from the generated list of candidate network credentials. For example, the position information may indicate that the wireless device is operating in Europe. In such a situation, the wireless device may exclude those network credentials (e.g., PLMNs, wireless networks, etc.) that are exclusive to Africa, Asia, Central America, Middle East, North America, and so on. That is, the wireless device would select those network credentials that have associated RAT(s) and frequency band information that are known to function in Europe for inclusion in the list of candidate network credentials.

At Act 310, the wireless device may register with a wireless network associated with one of the network credentials included in the generated list of candidate network credentials. As those of ordinary skill in the art appreciate, there are a number of factors that influence which wireless network is selected by a given wireless device. For example, a given wireless device may select a highest prioritized wireless network associated with the list of candidate network credentials. That is, the wireless device may select the wireless network that supports a preferred RAT. Or, the wireless device may select the wireless network that is providing the strongest signal strength.

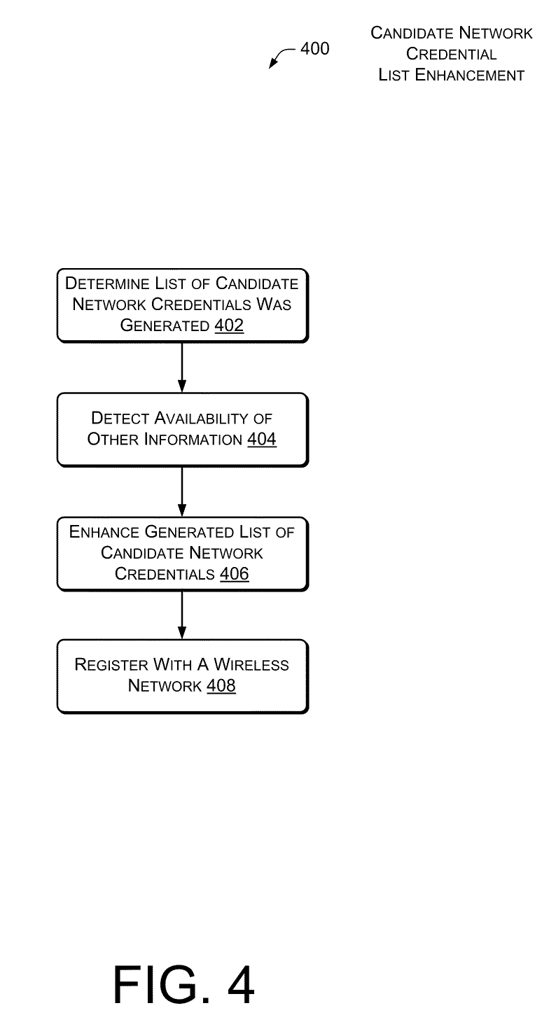

FIG. 4 is a flow diagram of a procedure 400 that may be used in connection with the procedure 300, for example, to further enhance a candidate network credential list. The procedure 300 may be designed to quickly generate the candidate network credential list to reduce the amount of time that is required for an associated wireless device to register with a wireless network. Therefore, the procedure 300 may obtain the position information and generate the candidate network credential list before all services associated with the wireless device are available. For example, in one implementation, the procedure 300 may generate the position information based on a time period elapsed between a transceiver disabled state and the transceiver enabled state, and generate the list of candidate network credentials based solely on this position information. The procedure 400 may be used to update such a generated list of candidate network credentials as other services and functionalities associated with the wireless device become available.

At Act 402, the wire device may determine that a list of candidate network credentials, such as a list of PLMN entries, was generated based on determined position information. At Act 404, the wireless device may detect that other information is now available, which may be used to enhanced the determined position information. Such other information may include position information obtained from a positioning technology (e.g., the position module 208) associated with the wireless device. In another implementation, such other information may be country or geographical information associated with a PLMN carrier or frequency detected by the wireless device. In yet another implementation, such other information may be location information determined based on an AC voltage level that the wireless device is currently coupled to.

At Act 406, the other information, considered individually or collectively, may be used to enhance the generated list of candidate network credentials. For example, the other information may enable the wireless device to add one or more network credentials to the generated list of candidate network credentials that were originally determined as incompatible with the position information generated at Act 304. Furthermore, the other information may enable the wireless device to remove one or more network credentials from the generated list of candidate network credentials that were originally determined as compatible with the position information generated at Act 304.

At Act 408, the wireless device may register with a wireless network associated with one of the network credentials included in the enhanced list of candidate network credentials. As those of ordinary skill in the art appreciate, there are a number of factors that influence which wireless network is selected by a given wireless device. For example, a given wireless device may select a highest prioritized wireless network associated with the list of candidate network credentials. That is, the wireless device may select the wireless network that supports a preferred RAT. Or, the wireless device may select the wireless network that is providing the strongest signal strength.

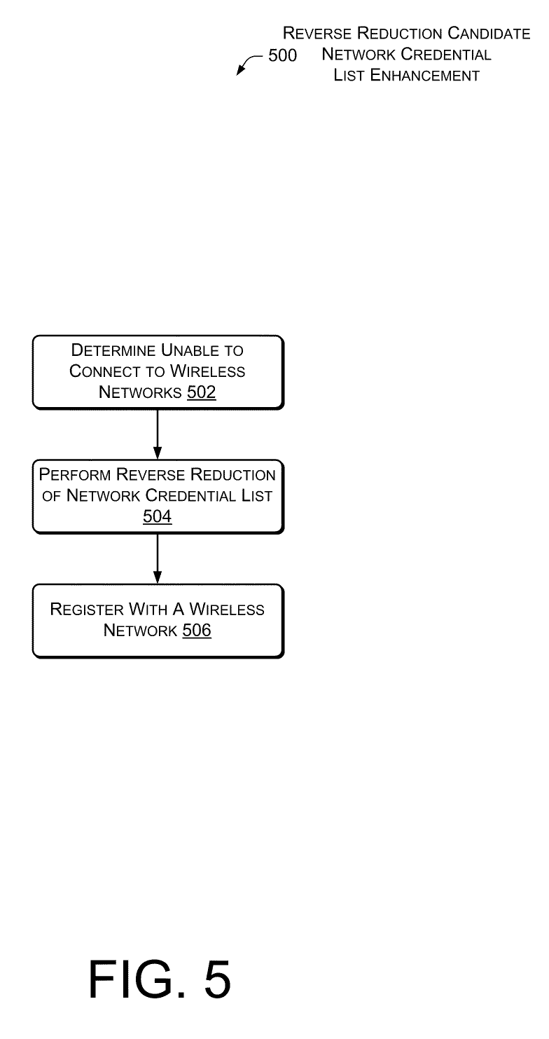

FIG. 5 is a flow diagram of a procedure 500 that may be used in connection with the procedures 300 and 400, for example, to further enhance a candidate network credential list. The procedures 300 and 400 may be designed to generate the candidate network credential list that includes wireless network entries that are likely available to the wireless device based on the determined position information. However, it is possible that the wireless device is not able to connect any of the wireless network entries associated with generated candidate network credential list. The procedure 500 is designed to add additional wireless network entries to the generated candidate network credential list after the wireless device determines that none of the wireless network entries in the candidate network credential list is available to the wireless device.

At Act 502, the wireless device may determine that it is unable to connect to any of the wireless networks identified in the generated candidate network credential list. This may occur if the determined position information is inconsistent with the actual position of the wireless device. In particular, if the determined position information is inconsistent with the actual position of the wireless device, the generated candidate network credential list may include wireless network entries that are not available in the geographical area that the wireless device is currently operating. There may be other factors that cause the wireless device to be unable to connect to any of the wireless networks identified in the generated candidate network credential list.

At Act 504, the wireless device may perform a reverse reduction of the generated candidate network credential list. In particular, the reverse reduction of the generated candidate network credential list may include incrementally adding network credentials to the generated candidate network credential list that were not included therein based on the position information generated at Act 304. In one implementation, the Act 308 generates the list of candidate network credentials by generating an ordered list of the stored network credentials based on the position information generated in Act 304 and eliminating those network credentials in the ordered list that are likely unavailable based on the generated position information. The reverse reduction process of Act 504 may incrementally add the network credential entries to the generated candidate network credential list starting from the highest ranked network credential of the ordered network credentials that were not initially included in the generated candidate network credential list. In another implementation, the Act 504 simply adds all of the network credentials that were originally not included in the generated candidate network credential list.

At Act 506, the wireless device may register with a wireless network associated with one of the network credentials included in the list of candidate network credentials generated at Act 504. As those of ordinary skill in the art appreciate, there are a number of factors that influence which wireless network is selected by a given wireless device. For example, a given wireless device may select a highest prioritized wireless network associated with the list of candidate network credentials. That is, the wireless device may select the wireless network that supports a preferred RAT. Or, the wireless device may select the wireless network that is providing the strongest signal strength.

For the purposes of this disclosure and the claims that follow, the terms “coupled” and “connected” have been used to describe how various elements interface. Such described interfacing of various elements may be either direct or indirect. Although the subject matter has been described in language specific to structural features and/or methodological acts, it is to be understood that the subject matter defined in the appended claims is not necessarily limited to the specific features or acts described. Rather, the specific features and acts are disclosed as preferred forms of implementing the claims. The specific features and acts described in this disclosure and variations of these specific features and acts may be implemented separately or may be combined.

1. A method, comprising:
storing a plurality of network credentials in a physical storage;
generating a list of candidate network credentials from the plurality of network credentials based on position information.

2. The method according to claim 1, wherein each of the stored plurality of network credentials is a public land mobile network (PLMN).

3. The method according to claim 1, further comprising selecting a network credential from the list of candidate network credentials and interfacing with a wireless network associated with the selected network credential.

4. The method according to claim 1, wherein the position information used to generate the list of candidate network credentials is determined based on a time period elapsed between a transceiver disabled state and the transceiver enabled state.

5. The method according to claim 1, wherein the position information used to generate the list of candidate network credentials is determined based on a time period elapsed between a wireless device power-off state and the wireless device power-on state.

6. The method according to claim 1, wherein the position information is based on an estimated geographical radius.

7. The method according to claim 6, wherein the estimated geographical radius is determined at least in part based on a time period elapsed between a transceiver disabled state and the transceiver enabled state, a predetermined or estimated center of the estimated geographical radius being a last known position before the transceiver disabled state.

8. The method according to claim 1, wherein the position information is obtained from a satellite positioning system.

9. The method according to claim 1, wherein the act of generating generates the list of candidate network credentials that includes public land mobile networks (PLMNs) available in a geographical area associated with the position information.

10. A method, comprising:
estimating a geographical radius based on a time period elapsed between a transceiver disabled state and the transceiver enabled state; and
generating a list of candidate network credentials based on the estimated geographical radius.

11. The method according to claim 10, wherein the act of generating generates a list of candidate network credentials available within the estimated geographical radius.

12. The method according to claim 10, further comprising calculating the estimated geographical radius based at least on a probable velocity associated with a wireless device incorporated the transceiver and a position of the wireless device before the transceiver enters the disabled state.

13. An apparatus, comprising:
a processor; and
a storage coupled to the processor, the storage configured to:
store a list of public land mobile networks (PLMNs), each PLMN in the list having associated radio access technology (RAT) information, and
store a subset list of PLMNs having associated RAT information compatible with position information.

14. The apparatus according to claim 13, wherein each PLMN in the list further includes associated frequency band information, and the stored subset list of PLMNs is restricted to PLMNs having associated RAT and frequency band information compatible with the position information.

15. The apparatus according to claim 13, wherein the position information is geographical related information obtained from satellite positioning information, short-range wireless communication, voltage level information, estimated geographical radius information, or information associated with an active PLMN discovered in a PLMN search process.

16. The apparatus according to claim 14, further comprising at least one transceiver coupled to the processor, the position information based on an elapsed time between a disabled state of the transceiver and an enabled state of the transceiver.

17. The apparatus according to claim 14, wherein the position information is geographical related information obtained from satellite positioning information.

18. The apparatus according to claim 14, wherein the position information is geographical related information obtained from short-range wireless communication.

19. The apparatus according to claim 14, wherein the position information is geographical related information obtained from information associated with an active PLMN discovered in a PLMN search process.

20. An apparatus, comprising:
a storage including a list of candidate network credentials, each of the candidate network credentials being included in the list based on an estimated geographical radius.

21. The apparatus according to claim 20, further comprising a transceiver, wherein the estimated geographical radius is based on an elapsed time between a disabled state of the transceiver and an enabled state of the transceiver.

22. The apparatus according to claim 21, wherein the network credentials are public land mobile networks (PLMNs).

23. The apparatus according to claim 20, wherein the list of candidate network credentials is a subset of stored network credentials.
